(19) United States
(12) Patent Application Publication
(10) Pub. No.: US 2014/0290538 A1
(43) Pub. Date: Oct. 2, 2014

(54) Methof of Providing Storage And Services For Valuables

(71) Applicant: WARD KRAFT, INC., Fort Scott, KS (US)

(72) Inventor: Ryan Kraft, Fort Scott, KS (US)

(73) Assignee: Ward Kraft, Inc., Fort Scott, KS (US)

(21) Appl. No.: 13/854,614

(22) Filed: Apr. 1, 2013

(51) Int. Cl. E05G 1/00

(52) U.S. Cl. CPC E05G 1/00
USPC 109/53

(57) ABSTRACT

A facility and services are provided for the storage of firearms and other valuables. The facility includes a secure, theft proof and fire proof structure for the storage of firearms, gold, and other variables in containers. The facility also provides services for the valuables, including cleaning, polishing, repairs, and maintenance. Insurance, research, sale, trading, and information services may also be provided by the facility.

### FIELD OF INVENTION

The field of the invention is the storage of valuable goods and related services.

### BACKGROUND

Guns or firearms are collected by many people as an investment. Persons who are hunters of diverse game frequently have a large number of various types of firearms and hunting weapons. It is inconvenient to store a large number of firearms in a home, because of the danger of theft and the danger of use by children or unauthorized persons.

Gold, precious metals, jewelry, gems, artwork, collectors' items, and other valuables are commonly kept in a safe deposit box or at the home of the owner; however, if the quantity of valuable goods becomes large, it is unwieldy to continue to keep the valuables in multiple safe deposit boxes, either at home or at a bank. Larger items such as guns and artwork cannot be kept in safe deposit boxes due to their size.

Typical locations for the storage of firearms and valuables do not provide services relating to the firearms and valuables being stored. Home storage areas for firearms and valuables frequently do not have safe, non-movable containers in which to store firearms or other valuables. In many situations it is not difficult for thieves to steal the firearms or valuables, or even the containers in which they are kept. It can also be difficult and expensive to insure valuables and/or firearms.

It would be very beneficial to have a location where guns and valuables could be stored in highly secure safes or containers. Such locations should also provide a variety of services to their customers in connection with the firearms and valuables.

### SUMMARY OF INVENTION

A facility is provided for the storage of firearms and valuables. The facility includes a secure, theft proof and fire proof structure for the storage of firearms, gold, gems, jewelry, larger pieces of artwork, and other variables. The facility also includes equipment, or secures third parties, to clean, polish, and/or repair the firearms, gold, precious metals, and other items. Additional equipment and resources are provided at or through the facility for researching, securing, and providing information about the firearms and other valuables stored and serviced at the facility. An operator of the facility uses the structure to safely store the valuables and uses the equipment and resources to research and secure current useful or interesting information about the valuables, their cleaning, service, repair and value. The information may be provided to the owners of the valuables via printed and/or electronic communication. The operator may also provide insurance for the valuables and a marketplace for the sale and trade of the valuables.

### BRIEF DESCRIPTION OF DRAWINGS

FIG. 1 is a chart depicting schematically the organization and service system described herein.

### DETAILED DESCRIPTION

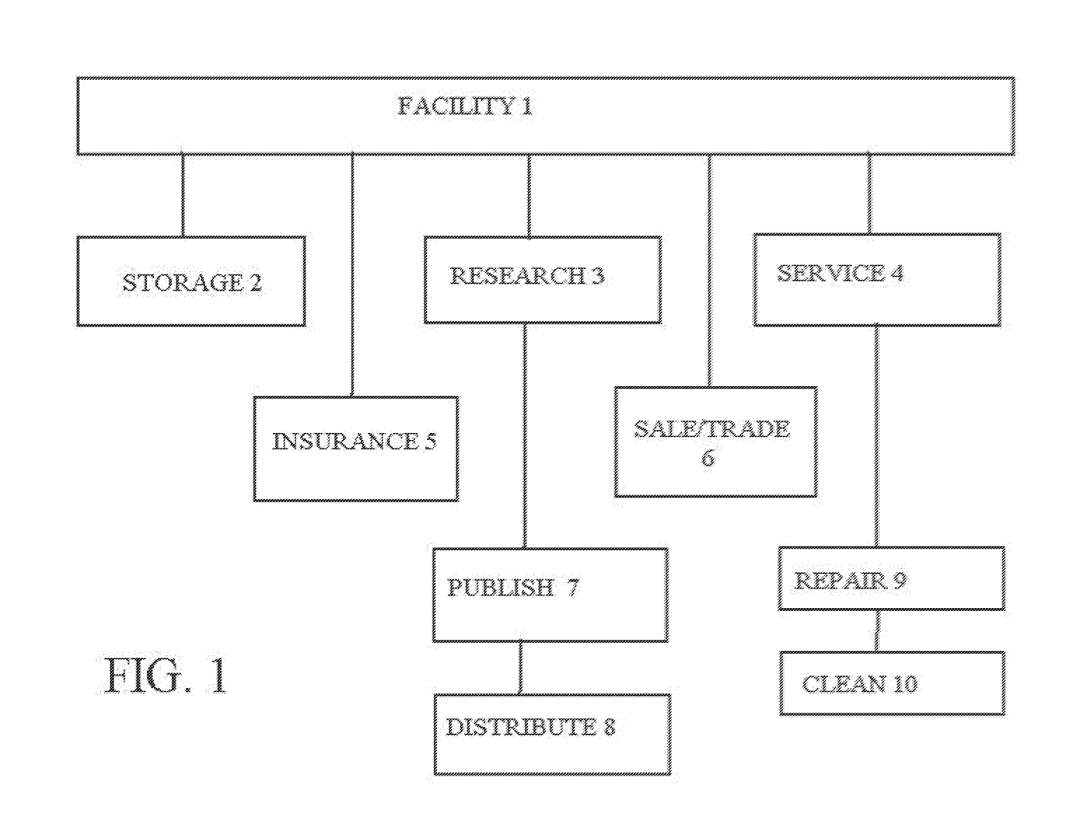

As shown schematically in FIG. 1, a facility 1 for the system includes a secure theft proof and fireproof storage location to safely house both firearms and other valuables. In most cases, this will require the facility 1 to have a secure vault or other secure facility 1 and secure storage containers 2 to store the valuables. The storage containers 2 for the firearms and valuables will be sized to house the goods appropriately and, of course, be sufficiently identifiable to match the owner with the firearms of valuables.

The storage facility 1 may allow the owners of the valuables access to the storage containers 2 via a key system similar to that of a safety deposit box, access via the operator of the facility, or both. The valuables stored in the storage containers 2 of the facility 1 may include gems, precious metals, gold, jewelry, works of art, firearms, antiques, collectables, and the like.

The containers 2 are sized to fit the various different types of valuables that may be stored in the facility 1. The containers 2 may be rooms with locked doors, locked closets, locked cases, locked drawers, or other housings that may be locked, dust free, and otherwise secure and protected from intruders, dust, dirt, and the elements. Specially sized cases for the valuables may in turn be locked and contained in the rooms, closets, and other housings.

In addition to providing storage, the operator of the facility or agents of the operator may provide services 4 to the owners of the valuables and firearms. In the case of firearms, the services 4 may include gun cleaning 10, gun sight services, gun repairs 9, and other services to keep the firearms in good working order and in an attractive, salable condition. In the case of gold, jewelry, artwork, and other valuables, the goods may be cleaned 10 and polished, if appropriate. Of course, the same services 4, including cleaning 10 and repairs 9 may be provided for jewelry, artwork, gems, and precious metals.

The operator may also perform services relating to the sale or trade 6 of firearms and valuables, providing a market for those who wish to buy and sell firearms and valuables. The operator of the facility may also make a market for the purchase, sale, and trading 6 of the goods.

Insurance 5 may be provided for the safekeeping of the firearms and valuables, as well as for their intrinsic value.

The operator of the facility 1 may also perform research 3 on a variety of subjects relating to the firearms and valuables, such as current values, history, technology, news events, care, maintenance, and political trends. The results of the research 3 may be published 7 and distributed 8 to the owners via printed reports, newsletters, magazines, or online.

As will be appreciated, the facility 1 described above will provide a single location, as opposed to multiple locations, for the storage of valuables, including smaller items such as coins, jewelry, artwork, and gems, as well as larger items such as bulk gold, firearms, and larger items of artwork. The facility 1 will also provide a variety of services 4 for the valuables stored therein including maintenance, repairs 9, servicing, cleaning 10, and trade and sale 6, as well as research 3, publications 7 and distribution 8 to uses. Additional services may include the provision of insurance 5 for the valuables.

I claim:

1. A method for storage, safekeeping, and maintenance of valuables comprising:
(a) providing a secure location for the storage of valuables, the location having containers for the storage of the valuable;
(b) storing the valuables in the containers;
(c) allowing access to the valuables in the containers; and
(d) performing services with respect to the valuables;

2. The method of claim 1 wherein the location is secured against fire, break-in and theft.

3. The method of claim 1 wherein the valuables include at least one of firearms, gems, gold, precious metals, works of art, antiques, collectibles and coins.

4. The method of claim 1 wherein the services include repairing the valuables.

5. The method of claim 1 wherein the services include cleaning of the valuables.

6. The method of claim 1 wherein the services include providing insurance for the valuables.

7. The method of claim 1 wherein the services include providing a market for the sale and trading of the valuables.

8. The method of claim 1 wherein the services include performing research with respect to the valuables.

9. The method of claim 1 wherein the services include publishing information about the valuables.

10. The method of claim 1 wherein the services include distributing information about the valuables.

11. The method of claim 1 wherein the valuables may be accessed by an operator of the storage location.

12. The method of claim 1 wherein the valuables may be accessed by an owner of the valuables.

13. The method of claim 1 wherein the services include performing research with respect to at least one of the value, price, sales, trades, history, recent events, technology, care, repair, or maintenance of the valuables.

14. The method of claim 1 wherein the containers are at least one of a locked closet, a locked room with doors, a closets, a locked case, a locked drawer, and a locked housing.

15. The containers of claim 14 wherein the locked containers are sized to fit the valuables may enclose and contain additional locked containers.
